(19) United States
(12) Patent Application Publication
(10) Pub. No.: US 2022/0295520 A1
(43) Pub. Date: Sep. 15, 2022

(54) METHOD AND DEVICE FOR TRANSMITTING DATA IN CONSIDERATION OF PRIORITY OF MAC CE

(71) Applicant: Samsung Electronics Co., Ltd., Suwon-si, Gyeonggi-do (KR)

(72) Inventors: Sangkyu BAEK, Suwon-si (KR); Hyunjeong KANG, Suwon-si (KR)

(21) Appl. No.: 17/634,351

(22) PCT Filed: Sep. 24, 2020
(86) PCT No.: PCT/KR2020/012947

§ 371 Date: Feb. 10, 2022

(30) Foreign Application Priority Data
Sep. 25, 2019 (KR) 10-2019-0118350

(51) Int. Cl. H04W 72/12; H04W 72/10; H04W 72/04

(52) U.S. Cl. CPC H04W 72/1268; H04W 72/10; H04W 72/0446; H04W 72/1284; H04W 80/02

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. According to the present disclosure, the issue of a resource for transmitting an scheduling request (SR) colliding with a resource for transmitting a Medium Access Control (MAC) Protocol Data Unit (PDU) can be easily resolved.

### TECHNICAL FIELD

The disclosure relates to a method of determining a priority between a plurality of uplink transmissions in a wireless communication system.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

The need for a method for solving a collision problem between a resource for transmitting a scheduling request (SR) and a resource for transmitting a medium access control (MAC) protocol data unit (PDU) and a method for solving a collision problem of a resource for transmitting two or more MAC PDUs has emerged.

### DISCLOSURE OF INVENTION

### Technical Problem

In a next-generation mobile communication system, a problem in which a resource for transmitting a scheduling request (SR) and a resource for transmitting a medium access control (MAC) protocol data unit (PDU) collide with each other and a problem in which resources for transmitting two or more MAC PDUs collide may occur.

### Solution to Problem

According to an embodiment of the disclosure, a method of controlling a terminal may include identifying whether a first uplink (UL) resource and a second UL resource overlap in time; determining, in case that the first UL resource and the second UL resource overlap in time, whether a medium access control (MAC) control element (CE) is included in at least one of the first UL resource or the second UL resource; and transmitting an UL resource including the MAC CE in the first UL resource and the second UL resource.

According to another embodiment of the disclosure, a terminal may include a transceiver; and a controller configured to identify whether a first uplink (UL) resource and a second UL resource overlap in time, to determine whether a medium access control (MAC) control element (CE) is included in at least one of the first UL resource or the second UL resource in case that the first UL resource and the second UL resource overlap in time, and to control the transceiver to transmit the UL resource including the MAC CE in the first UL resource and the second UL resource.

### Advantageous Effects of Invention

According to the disclosure, in a next generation mobile communication system, it is possible to easily solve a collision problem between a resource transmitting for a scheduling request (SR) and a resource for transmitting medium access control (MAC) protocol data unit (PDU) and a collision problem between resources for transmitting two or more MAC PDUs.

### BRIEF DESCRIPTION OF DRAWINGS

FIG. 1 illustrates a collision scenario between a scheduling request message and a MAC PDU.

FIG. 2 illustrates an operation process in which a terminal allocates a medium access control (MAC) control element (CE) and data to a MAC PDU.

FIG. 3 illustrates a method of determining priorities in resource collision between a scheduling request message and a MAC PDU (PUSCH).

FIG. 4 illustrates a method of determining priorities in resource collision between a scheduling request message and a MAC PDU (PUSCH).

FIG. 5 illustrates a method of determining priorities in resource collision between a scheduling request message and a MAC PDU (PUSCH).

FIG. 6 illustrates a method of determining priorities in resource collision between a scheduling request message and a MAC PDU (PUSCH).

FIG. 7 illustrates a method of determining a group of MAC CEs according to a priority of MAC CEs.

FIG. 8 illustrates a method of determining priorities in resource collision between a scheduling request message and a MAC PDU (PUSCH).

FIG. 9 illustrates a method of determining priorities in resource collision between a scheduling request message and a MAC PDU (PUSCH).

FIG. 10 illustrates a method of determining priorities in resource collision between a scheduling request message and a MAC PDU (PUSCH).

FIG. 11 illustrates a method of determining priorities in resource collision between a scheduling request message and a MAC PDU (PUSCH).

FIG. 12 illustrates a method of determining priorities in resource collision between a MAC PDU (PUSCH) and a scheduling request message of the same priority.

FIG. 13 illustrates a method of determining priorities in resource collision between a MAC PDU (PUSCH) and a scheduling request message of the same priority.

FIG. 14 illustrates a method of determining priorities in resource collision between a MAC PDU (PUSCH) and a scheduling request message of the same priority.

FIG. 15 illustrates a collision scenario between sequentially occurring MAC PDUs.

FIG. 16 illustrates a method of determining priorities in a collision scenario between MAC PDUs (PUSCHs).

FIG. 17 illustrates a method of determining priorities in a collision scenario between MAC PDUs (PUSCHs).

FIG. 18 illustrates a collision scenario between independently occurring MAC PDUs.

FIG. 19 illustrates a method of determining priorities in a collision scenario between MAC PDUs (PUSCHs).

FIG. 20 illustrates a method of determining priorities in a collision scenario between MAC PDUs (PUSCHs).

FIG. 21 illustrates a method of determining priorities in a collision scenario between MAC PDUs (PUSCHs).

FIG. 22 illustrates a method of configuring a decimal value priority for a logical channel.

FIG. 23 is a block diagram illustrating a structure of a base station according to an embodiment of the disclosure.

FIG. 24 is a block diagram illustrating the structure of a terminal according to an embodiment of the disclosure.

### MODE FOR THE INVENTION

In describing embodiments in this specification, descriptions of technical contents that are well known in the technical field to which the disclosure pertains and that are not directly related to the disclosure will be omitted. This is to more clearly convey the gist of the disclosure without obscuring the gist of the disclosure by omitting unnecessary description.

For the same reason, some components are exaggerated, omitted, or schematically illustrated in the accompanying drawings. Further, the size of each component does not fully reflect the actual size. In each drawing, the same reference numerals are given to the same or corresponding components.

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only these embodiments enable the disclosure to be complete, and are provided to fully inform the scope of the disclosure to those of ordinary skill in the art to which the disclosure pertains, and the disclosure is only defined by the scope of the claims. Like reference numerals refer to like components throughout the specification.

In this case, it will be understood that each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operational steps are performed on the computer or other programmable data processing equipment to generate a computer-executed process; thus, instructions for performing a computer or other programmable data processing equipment may provide steps for performing functions described in the message flow diagram block(s).

Further, each block may represent a module, a segment, or a portion of a code including one or more executable instructions for executing specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term ‘-unit’ used in this embodiment means software or hardware components such as FPGA or ASIC, and ‘-unit’ performs certain roles. However, ‘-unit’ is not limited to software or hardware. ‘-unit’ may be configured to reside in an addressable storage medium or may be configured to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more CPUs in a device or secure multimedia card.

In the following description, in describing the disclosure, when it is determined that a detailed description of a related well-known function or configuration may unnecessarily obscure the gist of the disclosure, a detailed description thereof will be omitted. Hereinafter, an embodiment of the disclosure will be described with reference to the accompanying drawings.

Hereinafter, a term identifying an access node used in the description, a term indicating network entities, a term indicating messages, a term indicating an interface between network objects, a term indicating various identification information and the like are exemplified for convenience of description. Accordingly, the disclosure is not limited to the terms described below, and other terms indicating objects having equivalent technical meanings may be used.

Hereinafter, for convenience of description, the disclosure uses terms and names defined in the 3rd generation partnership project long term evolution (3GPP LTE) standard, which is the latest standard among currently existing communication standards. However, the disclosure is not limited by the above terms and names, and may be equally applied to systems conforming to other standards. In particular, the disclosure may be applied to 3GPP new radio (NR: 5G mobile communication standard).

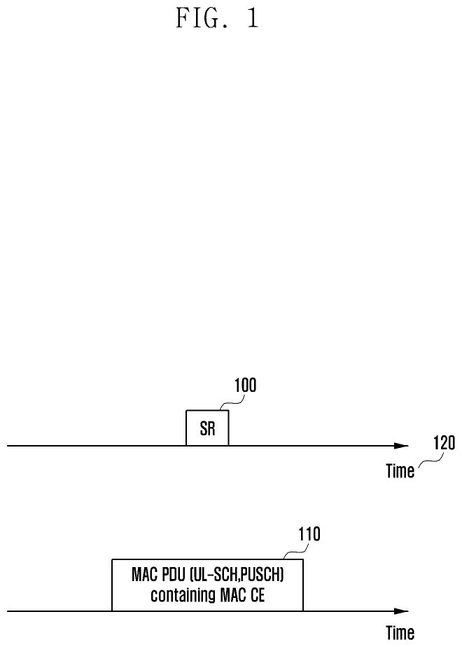

FIG. 1 illustrates a collision scenario between a scheduling request message and a medium access control (MAC) protocol data unit (PDU). In order to request an uplink (link sent by a terminal to a base station) resource for new data, the terminal may send a scheduling request (SR) message to the base station. Each logical channel may have a physical resource that can send an SR triggered by the logical channel, and a configuration of a physical resource that can send an SR is referred to as an SR configuration (100). Further, the terminal may receive allocation of a MAC PDU capable of transmitting data from the base station (110). For example, the terminal may receive allocation of uplink data for transmitting the MAC PDU from the base station. Such a MAC PDU is a resource transmitted corresponding to an uplink shared channel (UL-SCH) and a physical uplink shared channel, and may be allocated by the base station. The terminal may receive dynamic allocation of the resource for transmitting the MAC PDU by the base station or may be allocated with a configured grant (CG) repeated until released by a static configuration. In this case, the resource for transmitting the SR and the resource for transmitting the MAC PDU may overlap on a time axis 120 or time and frequency axes, and the terminal may have to select and transmit one of the two resources. This is referred to as a collision problem between an SR and a MAC PDU (or PUSCH).

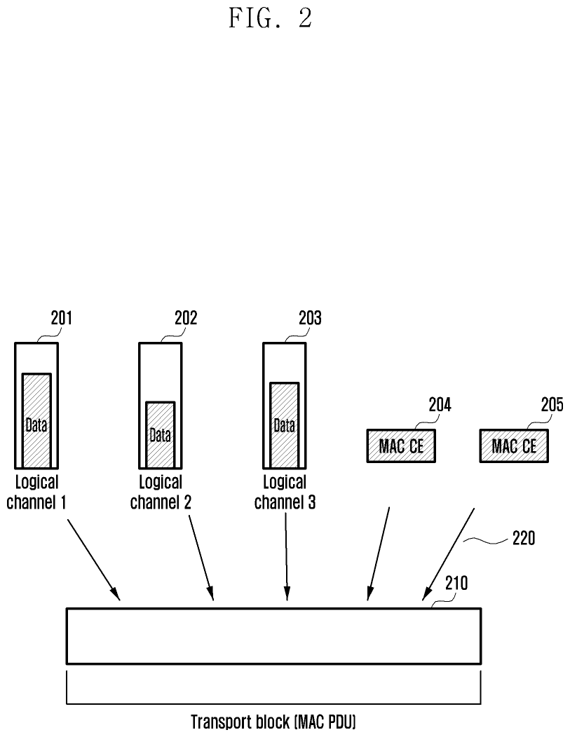

FIG. 2 illustrates an operation process in which a terminal allocates a medium access control (MAC) control element (CE) and data to a MAC PDU. In an embodiment of FIG. 2, it is assumed that there are total three logical channels of a logical channel 1, 201, a logical channel 2, 202, and a logical channel 3, 203 and two MAC CEs 204 and 205. However, this is an embodiment, and the number of logical channels configured by the terminal at one time point and the number of MAC CEs in which the terminal should transmit at one time point are not related to the disclosure. When the terminal receives allocation of a transport block (TB) 210, the terminal may receive allocation of a certain amount of radio resources according to a priority of each logical channel and MAC CE, and include data of the logical channel and the MAC CE in a transport block 220. The transport block is a term used in a physical layer, and in a MAC layer, it is referred to as a MAC protocol data unit (PDU). In this case, a process of allocating a radio resource of the MAC PDU to a plurality of logical channels is referred to as logical channel prioritization (LCP). An operation process of allocating a MAC CE and data to the MAC PDU is referred to as multiplexing, and a logical channel prioritization process means a part of the multiplexing operation.

For the multiplexing and logical channel prioritization process, it is necessary to configure values that determine how much priority each logical channel has, how much transmission speed should be guaranteed, and on what resource it may be transmitted. For this, values such as a priority value in which a low value has a high priority, a prioritized bit rate (PBR), and bucket size duration (BSD) may be configured; thus, a logical channel prioritization operation may be performed. Further, in each logical channel, restrictions such as a list of cells in which actual data may be transmitted and subcarrier spacing may also be configured, and by such a restriction, data may be transmitted only with radio resources allocated according to specific conditions. In an embodiment, there may be an indicator indicating whether the logical channel is a logical channel corresponding to an ultra reliable and low latency communication (URLLC) service. In this case, a logical channel in which an URLLC indicator is configured may use a resource corresponding to the URLLC service. For this, the base station may configure a field value such as URLLCDataAllowed. It may be indicated that a resource corresponding to the URLLC service may be used based on a field value such as URLLCDataAllowed. In another embodiment, a logical channel in which an URLLC indicator is configured may preferentially use a resource corresponding to an URLLC service over a logical channel in which an URLLC indicator is not configured. Even in this case, similarly, for example, by configuring a field value such as URLLCDataAllowed, it may be indicated that a resource corresponding to the URLLC service may be preferentially used.

In general, in a 4G (4th Generation, 4th generation mobile communication) system, only each logical channel has a priority value, and the MAC CEs 204 and 205 have only a relative priority according to the type thereof, and it has been assumed so that each MAC CE has an absolutely higher priority or an absolutely lower priority than that of data of a logical channel. However, in the case of a service requiring fast data transmission, such as a URLLC service, it is necessary to have a higher priority than that of some MAC CEs. To this end, the MAC CE may also participate in logical channel prioritization with a priority value. A priority value of the MAC CE may be configured by an RRC setup or reconfiguration message. However, in some embodiments, the priority value may be included in a system information block and transmitted to the terminal by the base station. However, when a configuration value of such a priority is not transmitted, the terminal may apply a priority of the MAC CE using a predefined default value. In another embodiment, the priority of the MAC CE may be configured by a priority of a logical channel that triggers the MAC CE. For example, in the case of a buffer status report (BSR) MAC CE, a priority value of a logical channel with a highest priority among a logical channel that has triggered the BSR or a logical channel with data remaining at a time point of sending the BSR may be a priority value of the corresponding BSR.

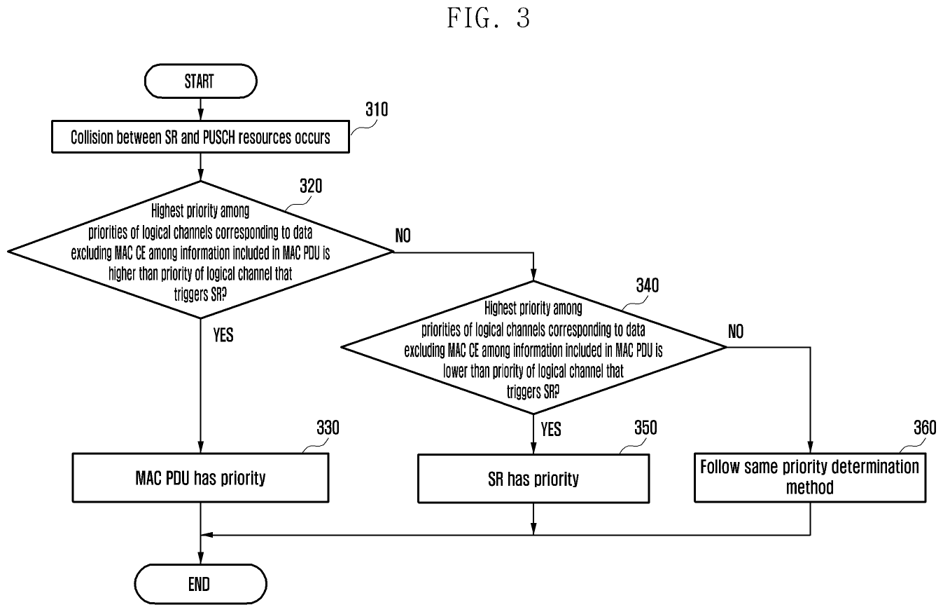

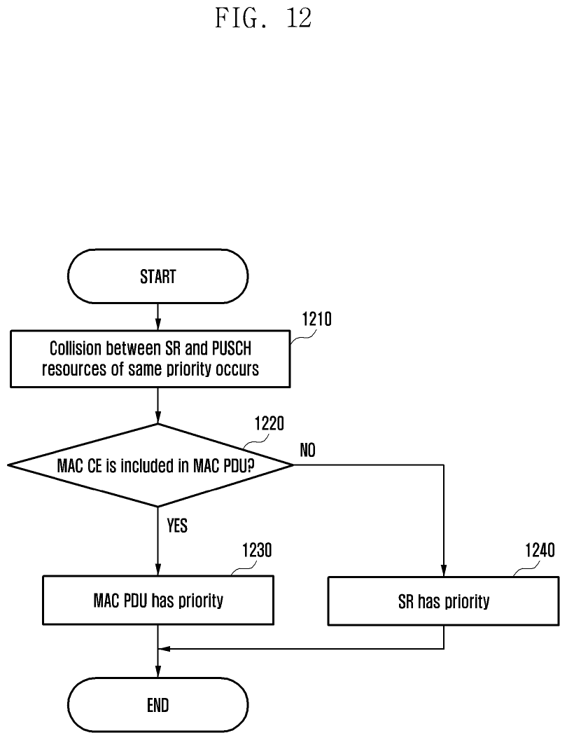

FIG. 3 illustrates a method of determining priorities in resource collision between a scheduling request message and a MAC PDU (PUSCH). A resource collision between the SR and PUSCH may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In case that a resource collision between the SR and the MAC PDU (PUSCH) occurs (310), the terminal needs to select and transmit one of the two resources. To this end, the terminal needs to identify whether a highest priority (priority of a logical channel having a lowest priority value) among priorities of logical channels corresponding to data excluding the MAC CE among information included in the MAC PDU is higher than a priority of a logical channel that triggers the SR (320). Here, the logical channel corresponding to data is a logical channel corresponding to an RLC device, and refers to a logical channel connecting a MAC layer and an RLC layer. The MAC CE may have a logical channel ID indicating which MAC CE it is, but the logical channel ID does not mean an actual logical channel. A highest priority among priorities of logical channels corresponding to data excluding the MAC CE among information included in the MAC PDU may be defined as a priority of the corresponding MAC PDU. In step 320, if a highest priority among priorities of logical channels corresponding to data excluding MAC CE among information included in the MAC PDU is higher than a priority of a logical channel that triggers the SR, it is considered that the priority of the MAC PDU is higher; thus, the MAC PDU may have a priority (330). For example, transmission of a MAC PDU may take precedence over transmission of an SR. Because the MAC PDU has a priority, the MAC PDU may be transferred to a lower physical layer. If a highest priority among priorities of logical channels corresponding to data excluding the MAC CE among information included in the MAC PDU is lower than a priority of a logical channel that triggers the SR (340), it is considered that the priority of the SR is higher; thus, the SR may have a priority (350). For example, transmission of an SR may take precedence over transmission of a MAC PDU. Because the SR has a priority, the SR may be transferred to a lower physical layer or SR transmission may be requested to the physical layer. If the two priorities are the same, it is possible to determine which one has a priority by the same priority determination method (360). The same priority determination method may be one of methods described with reference to FIGS. 12, 13, and 14. Accordingly, a specific method of determining the same priority will be described later.

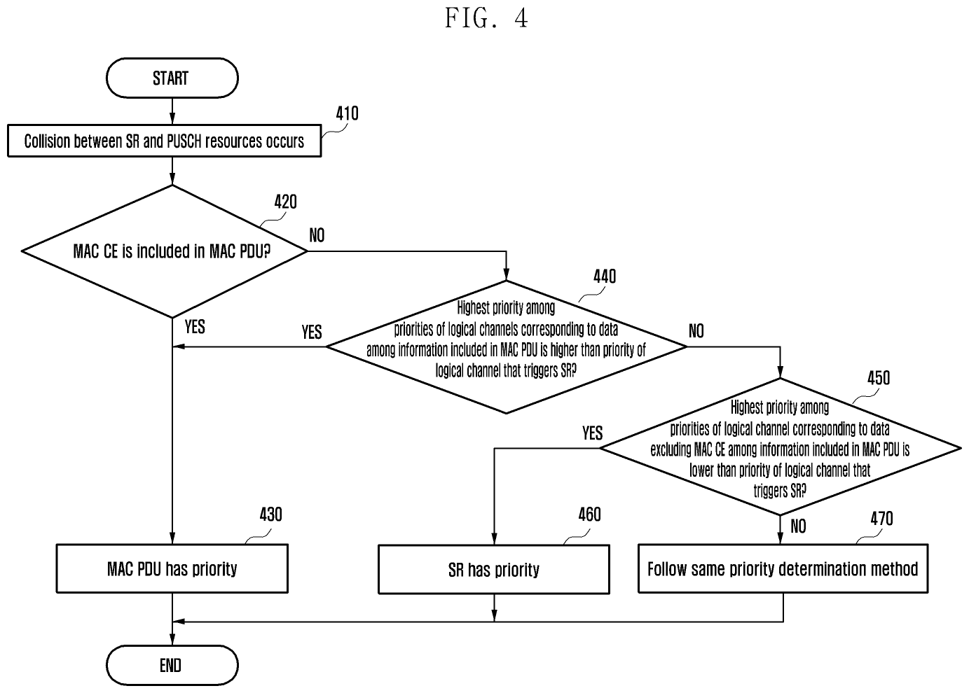

FIG. 4 illustrates a method of determining priorities in resource collision between a scheduling request message and a MAC PDU (PUSCH). A collision between SR and PUSCH resources may mean that the SR is triggered and should be transmitted from a configured SR resource. Accordingly, there is situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs (410), the terminal needs to select and transmit one of the two resources. In this case, whether the MAC CE is included in the MAC PDU may be one of determination factors of a prioritization process of selecting a resource (420). It may be considered that the MAC CE should be processed first with a higher priority than that of data. When the MAC CE is included in the MAC PDU, it is considered that a priority of the MAC PDU is higher because the MAC CE is included in the MAC PDU; thus, the MAC PDU may have a priority (430). For example, transmission of the MAC PDU may take precedence over transmission of the SR. Because the MAC PDU has a priority, the MAC PDU may be transferred to a lower physical layer. In this case, even if the SR has been triggered, the SR may not be transferred to a lower physical layer because it has a lower priority than that of the MAC PDU. The MAC CE described in step 420 may be limited to MAC CEs excluding a MAC CE for padding, a recommended bit rate query MAC CE, and a MAC CE with a low priority such as a padding buffer status report (BSR).

If the MAC CE is not included in the MAC PDU, it is necessary to identify whether a highest priority (a priority of a logical channel having a lowest priority value) among priorities of logical channels corresponding to data among information included in the MAC PDU is higher than a priority of a logical channel that triggers the SR (440). The logical channel corresponding to data is a logical channel corresponding to an RLC device, and refers to a logical channel connecting a MAC layer and an RLC layer. The MAC CE may have a logical channel ID indicating which MAC CE it is. However, the logical channel ID does not mean an actual logical channel. A highest priority among priorities of logical channels corresponding to data among information included in the MAC PDU may be defined as a priority of the corresponding MAC PDU. In step 440, if a highest priority among priorities of logical channels corresponding to data among information included in the MAC PDU is higher than a priority of a logical channel that triggers the SR, it is considered that the priority of the MAC PDU is higher; thus, the MAC PDU may have a priority (430). Because the MAC PDU has a priority, the MAC PDU may be transferred to a lower physical layer. If a highest priority among priorities of logical channels corresponding to data among information included in the MAC PDU is lower than a priority of a logical channel that triggers the SR (450), it is considered that the priority of the SR is higher; thus the SR may have a priority (460). Because the SR has a priority, the SR may be transferred to a lower physical layer or SR transmission may be requested to the physical layer. If the two priorities are the same, it is possible to determine which one has a priority by the same priority determination method (470). The same priority determination method may be one of methods described with reference to FIGS. 12, 13 and 14. Accordingly, a specific method of determining the same priority will be described later.

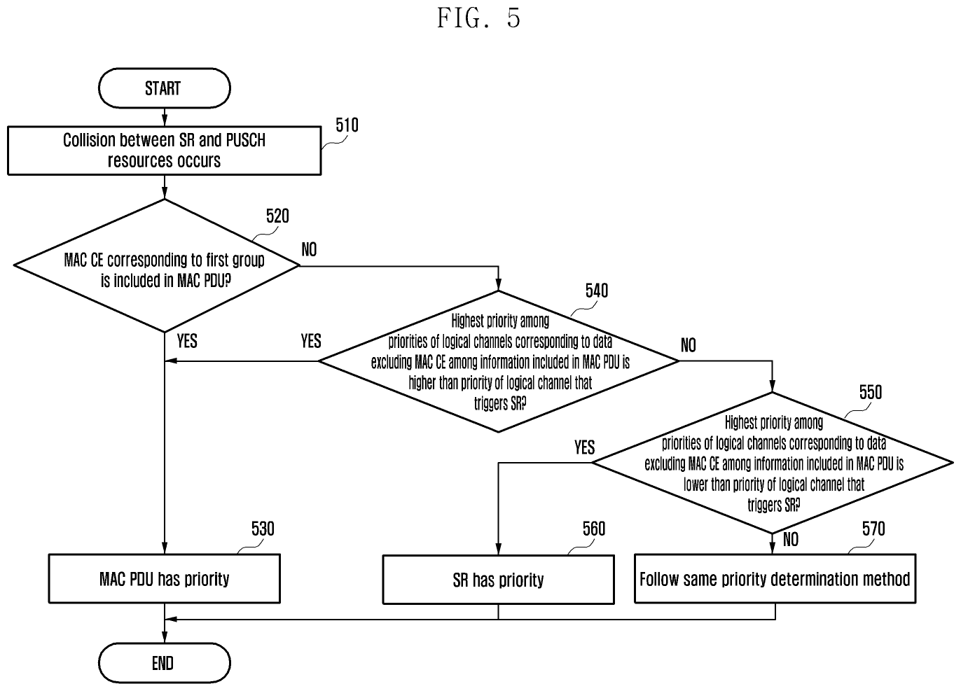

FIG. 5 illustrates a method of determining priorities in resource collision between a scheduling request message and a MAC PDU (PUSCH). A collision between SR and PUSCH resources may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs (510), a process of selecting and transmitting one of the two resources is required. In this case, whether a specific MAC CE is included in the MAC PDU may be one of determination factors of a prioritization process of selecting a resource (520). For example, the specific MAC CE may be a MAC CE considered to be first processed with a higher priority than that of data among all MAC CEs. In the disclosure, such a MAC CE is referred to as MAC CEs corresponding to a first group. Otherwise, MAC CEs considered acceptable to be processed with a lower priority than that of data are referred to as MAC CEs corresponding to a second group. When the MAC PDU includes a MAC CE corresponding to the first group, it is considered that the priority of the MAC PDU is higher because the MAC CE corresponding to the first group is included in the MAC PDU; thus, the MAC PDU may have a priority (530). Because the MAC PDU has a priority, the MAC PDU may be transferred to a lower physical layer. Even if the SR has been triggered, the SR may not be transferred to the lower physical layer because it has a lower priority than that of the MAC PDU. The MAC CE corresponding to the first group described in step 520 may be, for example, a regular BSR, a periodic BSR, a beam failure recovery (BFR) request, and the like. The MAC CE corresponding to the second group may be a MAC CE for padding, a recommended bit rate query MAC CE, and a MAC CE of a low priority such as a padding buffer status report (BSR). However, whether the MAC CE corresponding to the first group or the MAC CE corresponding to the second group is selected may vary according to an embodiment.

For example, it may be determined that the MAC CE corresponding to the regular BSR, the periodic BSR, the BFR request and the like generally needs to be transmitted with a priority over data. Accordingly, the base station may configure the terminal to transmit a MAC CE corresponding to the regular BSR, the periodic BSR, the BFR request and the like with a priority over the data. Accordingly, when it is determined that a MAC CE corresponding to the configured regular BSR, periodic BSR, and BFR request is included in the MAC PDU, the terminal may determine that the MAC PDU has a priority over the SR.

If the MAC PDU does not include a MAC CE corresponding to the first group, it is necessary to identify whether a highest priority (a priority of a logical channel having a lowest priority value) among priorities of logical channels corresponding to data among information included in the MAC PDU is higher than a priority of a logical channel that triggers the SR (540). The logical channel corresponding to data is a logical channel corresponding to an RLC device, and refers to a logical channel connecting a MAC layer and an RLC layer. The MAC CE may have a logical channel ID indicating which MAC CE it is, but the logical channel ID does not mean an actual logical channel. A highest priority among priorities of logical channels corresponding to data among information included in the MAC PDU may be defined as a priority of the corresponding MAC PDU. In step 540, if a highest priority among priorities of logical channels corresponding to data among information included in the MAC PDU is higher than a priority of a logical channel that triggers the SR, it is considered that the priority of the MAC PDU is higher; thus, the MAC PDU may have a priority (530). Because the MAC PDU has a priority, the MAC PDU may be transferred to a lower physical layer. If a highest priority among priorities of logical channels corresponding to data among information included in the MAC PDU is lower than a priority of a logical channel that triggers the SR (550), it is considered that the priority of the SR is higher; thus, the SR may have a priority (560). Because the SR has a priority, the SR may be transferred to a lower physical layer or SR transmission may be requested to the physical layer. If the two priorities are the same, it is possible to determine which one has a priority by the same priority determination method (570). The same priority determination method may be one of methods described with reference to FIGS. 12, 13, and 14. Accordingly, a specific method of determining the same priority will be described later.

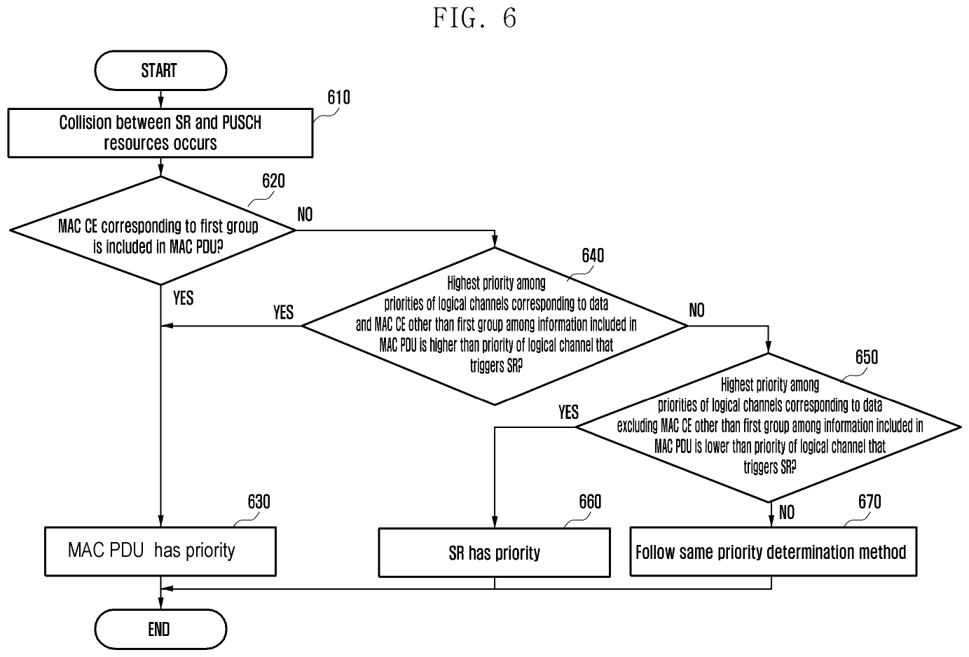

FIG. 6 illustrates a method of determining priorities in resource collision between a scheduling request message and a MAC PDU (PUSCH). A resource collision between an SR and a PUSCH may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs (610), the terminal needs to select and transmit one of the two resources. In this case, whether a specific MAC CE is included in the MAC PDU may be one of determination factors of a prioritization process of selecting a resource (620). The specific MAC CE may be a MAC CE considered to be first processed with a higher priority than that of data among all MAC CEs, and in the disclosure, such a MAC CE is referred to as MAC CEs corresponding to a first group. Otherwise, MAC CEs considered acceptable to be processed with a lower priority than that of data are referred to as MAC CEs corresponding to a second group. When the MAC PDU includes a MAC CE corresponding to the first group, it is considered that the priority of the MAC PDU is higher because the MAC CE corresponding to the first group is included in the MAC PDU; thus, the MAC PDU may have a priority (630). Because the MAC PDU has a priority, the MAC PDU may be transferred to a lower physical layer. In this case, even if the SR has been triggered, the SR may not be transferred to the lower physical layer because it has a lower priority than that of the MAC PDU. The MAC CE corresponding to the first group described in step 620 may be, for example, a regular BSR, a periodic BSR, a beam failure recovery (BFR) request, and the like. The MAC CE corresponding to the second group may be a MAC CE for padding, a recommended bit rate query MAC CE, and a MAC CE of a low priority such as a padding buffer status report (BSR). However, whether the MAC CE corresponding to the first group or the MAC CE corresponding to the second group is selected may vary according to an embodiment.

If the MAC PDU does not include a MAC CE corresponding to the first group, it is necessary to identify whether a highest priority (a priority of a logical channel having a lowest priority value) among a priority of a MAC CE (a MAC CE corresponding to a second group) other than the first group and a priority of a logic channel corresponding to data among information included in the MAC PDU is higher than a priority of a logical channel that triggers the SR (640). For this, a priority value may be given to the MAC CE. Here, the logical channel corresponding to data is a logical channel corresponding to an RLC device, and refers to a logical channel connecting a MAC layer and an RLC layer. The MAC CE may have a logical channel ID indicating which MAC CE it is, but the logical channel ID does not mean an actual logical channel. A highest priority among priorities of logical channels corresponding to data among information included in the MAC PDU may be defined as a priority of the corresponding MAC PDU. In step 640, if a highest priority among a priority of a MAC CE (a MAC CE corresponding to a second group) other than the first group and a priority of the logical channel corresponding to data among information included in the MAC PDU is higher than a priority of a logical channel that triggers the SR, it is considered that the priority of the MAC PDU is higher; thus, the MAC PDU may have a priority (630). Because the MAC PDU has a priority, the MAC PDU may be transferred to a lower physical layer. If a highest priority among a priority of a MAC CE (a MAC CE corresponding to a second group) other than the first group and a priority of a logical channel corresponding to data among information included in the MAC PDU is lower than a priority of a logical channel that triggers the SR (650), it is considered that the priority of the SR is higher; thus the SR may have a priority (660). Because the SR has a priority, the SR may be transferred to a lower physical layer or of SR transmission may be requested to the physical layer. If the two priorities are the same, it is possible to determine which one has a priority by the same priority determination method (670). The same priority determination method may be one of methods described with reference to FIGS. 12, 13 and 14. Accordingly, a specific method of determining the same priority will be described later.

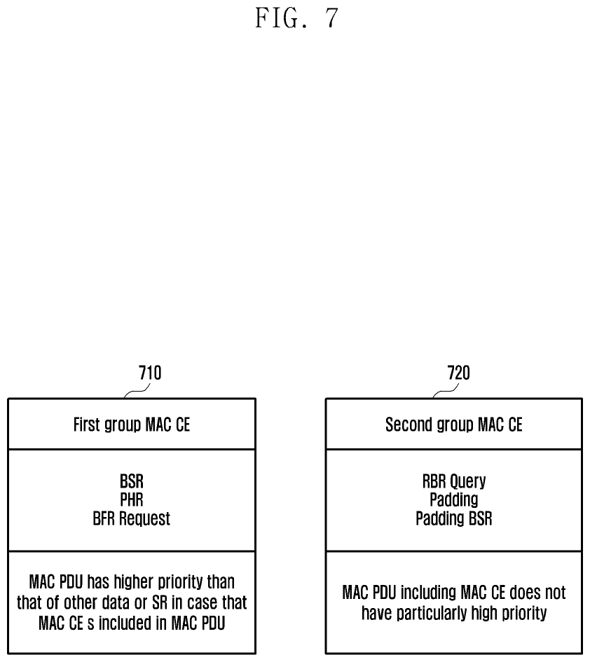

FIG. 7 illustrates a method of determining a group of MAC CEs according to a priority of MAC CEs. The MAC CE is used as a control message in a MAC layer, is defined for various purposes, and may be identified using a logical channel ID. Any MAC CE thereof may be a MAC CE considered to be first processed with a higher priority than that of data or the SR. In the disclosure, such a MAC CE is referred to as a MAC CE corresponding to a first group hereinafter. Otherwise, a MAC CE considered acceptable to be processed with a lower priority than that of data or the SR is referred to as a MAC CE corresponding to a second group. When the MAC PDU includes or is going to include a MAC CE corresponding to the first group, it is considered that a priority of the MAC PDU is higher because the MAC CE is included in the MAC PDU corresponding to the first group; thus, the MAC PDU may have a priority (710). If the MAC PDU does not include a MAC CE, includes only a MAC CE corresponding to the second group, or does not include a MAC CE corresponding to the first group, the MAC PDU does not have a particularly high priority, and a priority of the MAC PDU may be determined by priorities of logical channels corresponding to data included in the corresponding MAC PDU (720). The MAC CE corresponding to the first group may be, for example, a regular BSR, a periodic BSR, a beam failure recovery (BFR) request, and the like. The MAC CE corresponding to the second group may be a MAC CE for padding, a recommended bit rate query MAC CE, and a MAC CE of a low priority such as a padding buffer status report (BSR). However, whether the MAC CE corresponding to the first group or the MAC CE corresponding to the second group is selected may vary according to an embodiment.

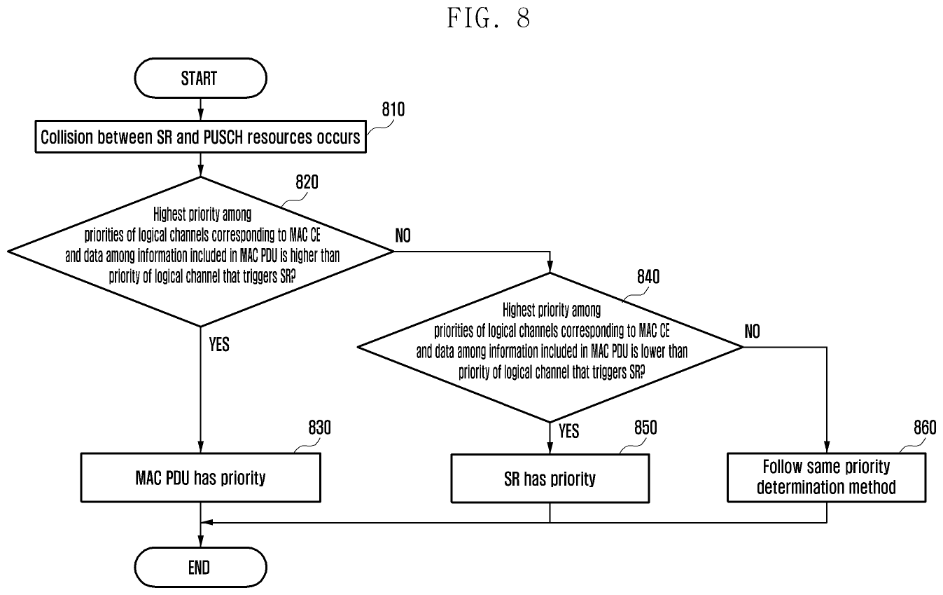

FIG. 8 illustrates a method of determining priorities in resource collision between a scheduling request message and a MAC PDU (PUSCH). A collision between the SR and PUSCH resources may mean that the SR is triggered and should be transmitted from a configured SR resource. Accordingly, there is a situation in which a MAC PDU to be transmitted is generated and should be transmitted from a corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs (810), the terminal needs to select and transmit one of the two resources. In this case, whether a specific MAC CE is included in the MAC PDU or which MAC CE is included in the MAC PDU may be one of determination factors of a prioritization process of selecting a resource. For this, a priority value may be given to the MAC CE. The priority value of the MAC CE may be determined by the base station by a radio resource control (RRC) message or a system information block (SIB) and transmitted to the terminal. However, in another embodiment, a default value may be designated. For example, the BSR may have a value of 3.5, the PHR may have a value of 2, and the padding may have a value of 17 as a default value. However, in the case of the BSR, a highest priority among a priority of the logical channel that triggers the BSR and a priority of a logical channel having data to be sent may be configured as a priority of the BSR. In this case, the priority of the BSR does not become a fixed value by a configuration of the base station.

In order to compare priorities of the SR and the MAC PDU, the terminal needs to identify whether a highest priority (a logical channel having a lowest priority value) among priorities of logical channels corresponding to the MAC CE and data among information included in the MAC PDU is higher than a priority of a logical channel that triggers the SR (820). The logical channel corresponding to data is a logical channel corresponding to an RLC device, and refers to a logical channel connecting a MAC layer and an RLC layer. The MAC CE may have a logical channel ID indicating which MAC CE it is, but the logical channel ID does not mean an actual logical channel. A highest priority among priorities of logical channels corresponding to the MAC CE and data among information included in the MAC PDU may be defined as a priority of the corresponding MAC PDU. In step 820, if a highest priority among priorities of logical channels corresponding to the MAC CE and data among information included in the MAC PDU is higher than a priority of a logical channel that triggers the SR, it is considered that the priority of the MAC PDU is higher; thus, the MAC PDU may have a priority (830). Because the MAC PDU has a priority, the MAC PDU may be transferred to a lower physical layer. If a highest priority among priorities of logical channels corresponding to the MAC CE and data among information included in the MAC PDU is lower than a priority of a logical channel that triggers the SR (840), it is considered that the priority of the SR is higher; thus, the SR may have a priority (850). Because the SR has a priority, the SR may be transferred to a lower physical layer or SR transmission may be requested to the physical layer. If the two priorities are the same, it is possible to determine which one has a priority by the same priority determination method (860). The same priority determination method may be one of methods described with reference to FIGS. 12, 13 and 14. Accordingly, a specific method of determining the same priority will be described later.

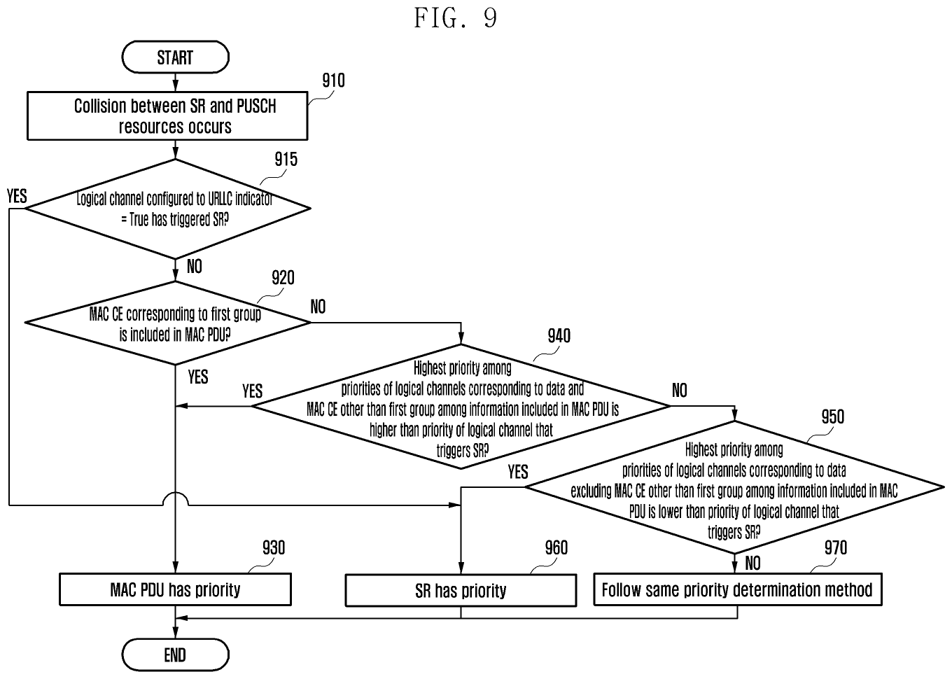

FIG. 9 illustrates a method of determining priorities in resource collision between a scheduling request message and a MAC PDU (PUSCH). A collision between SR and PUSCH resources may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs (910), a process of selecting and transmitting one of the two resources is required. In this case, whether the logical channel that triggers the MAC PDU has an indicator indicating that a specific service is processed (915) and whether a specific MAC CE is included in the MAC PDU may be one of determination factors of a prioritization process of selecting a resource (920). Each logical channel or radio bearer may be established for the purpose of processing data requiring a high priority such as a URLLC service. In order to apply data requiring a high priority such as the URLLC service to a communication protocol, the base station may configure an indicator indicating that a specific service is processed upon each logical channel setup or radio bearer setup. In an embodiment of FIG. 9, it is assumed that a URLLC indicator is configured. If the URLLC indicator is configured to true, the terminal may identify whether a logical channel corresponding to the URLLC indicator configured to true has triggered the SR (915). If a logical channel in which the URLLC indicator is configured to true has triggered the SR, the SR may have to be transmitted quickly with a priority (960). If the URLLC indicator of a logical channel that triggers the SR is not configured to true, the terminal may select a resource in consideration of whether a specific MAC CE is included (920). In this case, a specific MAC CE may be a MAC CE considered to be processed first with a higher priority than that of data among all MAC CEs. In the disclosure, the MAC CE determined to be processed first with the high priority is referred to as a MAC CE corresponding to the first group. Otherwise, a MAC CE considered acceptable to be processed with a lower priority than that of data is referred to as a MAC CE corresponding to the second group. If the MAC PDU includes a MAC CE corresponding to the first group, it is considered that the priority of the MAC PDU is higher because the MAC CE corresponding to the first group is included in the MAC PDU; thus, the MAC PDU may have a priority (930). Because the MAC PDU has a priority, the MAC PDU may be transferred to a lower physical layer. Even if the SR has been triggered, the SR may not be transferred to the lower physical layer because it has a lower priority than that of the MAC PDU. The MAC CE corresponding to the first group described in step 920 may be, for example, a regular BSR, a periodic BSR, a beam failure recovery (BFR) request, and the like. The MAC CE corresponding to the second group may be a MAC CE for padding, a recommended bit rate query MAC CE, and a MAC CE of a low priority such as a padding buffer status report (BSR). However, whether the MAC CE corresponding to the first group or the MAC CE corresponding to the second group is selected may vary according to an embodiment.

If a MAC CE corresponding to the first group is not included in the MAC PDU, it is necessary to identify whether a highest priority (a priority of a logical channel having a lowest priority value) among a priority of a MAC CE (e.g., a MAC CE corresponding to a second group) other than the first group among information included in the MAC PDU and a priority of a logical channel corresponding to data is higher than a priority of a logical channel that triggers the SR (940). For this, a priority value may be given to the MAC CE. Here, the logical channel corresponding to data is a logical channel corresponding to an RLC device, and refers to a logical channel connecting a MAC layer and an RLC layer. The MAC CE may have a logical channel ID indicating which MAC CE it is, but the logical channel ID does not mean an actual logical channel. A highest priority among priorities of logical channels corresponding to data among information included in the MAC PDU may be defined as a priority of the corresponding MAC PDU. In step 940, if a highest priority among a priority of a MAC CE (a MAC CE corresponding to a second group) other than the first group among information included in the MAC PDU and a priority of a logical channel corresponding to data is higher than a priority of a logical channel that triggers the SR, it is considered that the priority of the MAC PDU is higher; thus, the MAC PDU may have a priority (930). Because the MAC PDU has a priority, the MAC PDU may be transferred to a lower physical layer. If a highest priority among a priority of a MAC CE (a MAC CE corresponding to a second group) other than the first group and a priority of the logical channel corresponding to data among information included in the MAC PDU is lower than a priority of a logical channel that triggers the SR (950), it is considered that the priority of the SR is higher; thus the SR may have a priority (960). Because the SR has a priority, the SR may be transferred to a lower physical layer or SR transmission may be requested to the physical layer. If the two priorities are the same, it is possible to determine which one has a priority by the same priority determination method (970). The same priority determination method may be one of methods described with reference to FIGS. 12, 13 and 14. Accordingly, a specific method of determining the same priority will be described later.

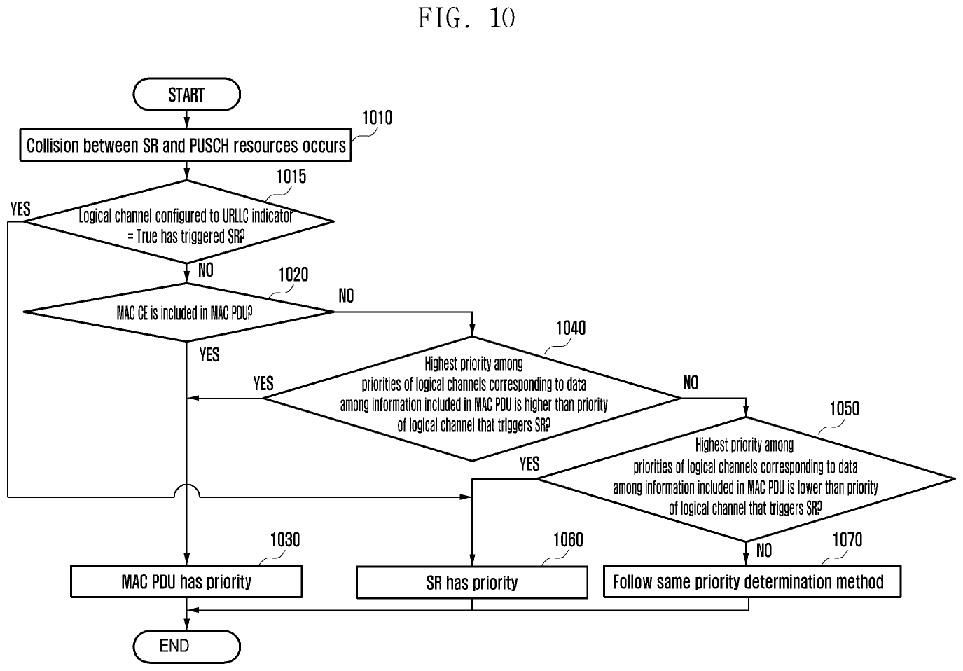

FIG. 10 illustrates a method of determining priorities in resource collision between a scheduling request message and a MAC PDU (PUSCH). A collision between the SR and PUSCH resources may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs (1010), a process of selecting and transmitting one of the two resources is required. In this case, whether a logical channel that triggers in the MAC PDU has an indicator indicating that a specific service is processed (1015) and whether the MAC CE is included in the MAC PDU may be one of determination factors of a prioritization process of selecting a resource (1020). Each logical channel or radio bearer may be established for the purpose of processing data requiring a high priority such as a URLLC service, and in order to apply data requiring a high priority such as the URLLC service to a communication protocol, upon each logical channel setup or radio bearer setup, an indicator indicating that a specific service is processed may be configured. In an embodiment of FIG. 10, it is assumed that a URLLC indicator is configured. For example, the base station may configure the URLCC indicator to the terminal through RRC signaling or the like. If the URLLC indicator is configured to true, the terminal may identify whether a logical channel corresponding to the URLLC indicator configured to true has triggered the SR (1015). If the logical channel in which the URLLC indicator is configured to true has triggered the SR, the SR may have to be transmitted quickly with a priority (1060). If the URLLC indicator of the logical channel that triggers the SR is not configured to true, the resource may be selected in consideration of whether the MAC CE is included in the MAC PDU (1020). In this case, it may be considered that the MAC CE should be processed first with a higher priority than that of data. If the MAC CE is included in the MAC PDU, it is considered that the priority of the MAC PDU is higher because the MAC CE is included in the MAC PDU; thus, the MAC PDU may have a priority (1030). Because the MAC PDU has a priority, the MAC PDU may be transferred to a lower physical layer. In this case, even if the SR has been triggered, the SR may not be transferred to a lower physical layer because it has a lower priority than that of the MAC PDU. The MAC CE described in step 1020 may be a MAC CE excluding a MAC CE for padding, a recommended bit rate query MAC CE, and a MAC CE of a low priority such as a padding buffer status report (BSR).

If the MAC CE is not included in the MAC PDU, it is necessary to identify whether a highest priority (a priority of a logical channel having a lowest priority value) among priorities of logical channels corresponding to data among information included in the MAC PDU is higher than a priority of a logical channel that triggers the SR (1040). Here, the logical channel corresponding to data is a logical channel corresponding to an RLC device, and refers to a logical channel connecting a MAC layer and an RLC layer. The MAC CE may have a logical channel ID indicating which MAC CE it is, but the logical channel ID does not mean an actual logical channel. A highest priority among priorities of logical channels corresponding to data among information included in the MAC PDU may be defined as a priority of the corresponding MAC PDU. In step 1040, if a highest priority among priorities of logical channels corresponding to data among information included in the MAC PDU is higher than a priority of a logical channel that triggers the SR, it is considered that the priority of the MAC PDU is higher; thus, the MAC PDU may have a priority (1030). Because the MAC PDU has a priority, the MAC PDU may be transferred to a lower physical layer. If a highest priority among priorities of logical channels corresponding to data among information included in the MAC PDU is lower than a priority of a logical channel that triggers the SR (1050), it is considered that the priority of the SR is higher; thus, the SR may have a priority (1060). Because the SR has a priority, the SR may be transferred to a lower physical layer or SR transmission may be requested to the physical layer. If the two priorities are the same, it is possible to determine which one has a priority by the same priority determination method (1070). The same priority determination method may be one of methods described with reference to FIGS. 12, 13 and 14. Accordingly, a specific method of determining the same priority will be described later.

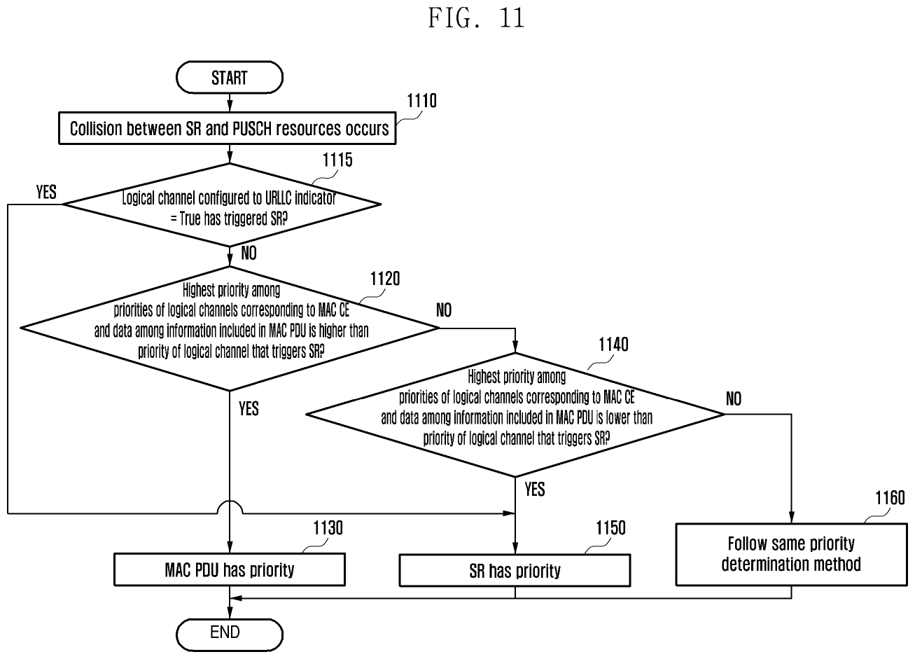

FIG. 11 illustrates a method of determining priorities in resource collision between a scheduling request message and a MAC PDU (PUSCH). A collision between the SR and PUSCH resources may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs (1110), the terminal needs to select and transmit one of the two resources. In this case, whether a logical channel that triggers the MAC PDU has an indicator indicating that a specific service is processed may be one of determination factors of a prioritization process of selecting a resource (1115). Each logical channel or radio bearer may be established for the purpose of processing data requiring a high priority such as a URLLC service. In order to apply data requiring a high priority such as the URLLC service to a communication protocol, the base station may configure an indicator indicating that a specific service is processed upon each logical channel setup or radio bearer setup. In an embodiment of FIG. 11, it is assumed that the base station configures a URLLC indicator to the terminal. If the URLLC indicator is configured to true, the base station may identify whether the logical channel corresponding to the URLLC indicator has triggered the SR (1115). If a logical channel in which the URLLC indicator is configured to true has triggered the SR, the SR may have to be transmitted quickly with a priority (1150). If the URLLC indicator of the logical channel that triggers the SR is not configured to true, whether a specific MAC CE is included in the MAC PDU or which MAC CE is included in the MAC PDU may be one of determination factors of a prioritization process of selecting a resource. For this, a priority value may be given to the MAC CE. The priority value of the MAC CE may be determined by the base station by a radio resource control (RRC) message or a system information block (SIB) and transmitted to the terminal. However, in another embodiment, a default value may be designated. For example, the BSR may have a value of 3.5, the PHR may have a value of 2, and the padding may have a value of 17 as the default value. However, in the case of the BSR, a highest priority among a priority of the logical channel that triggers the BSR and a priority of the logical channel having data to be sent may be configured as the priority of the BSR. In this case, the priority of the BSR does not become a fixed value by a configuration of the base station.

In order to compare the priorities of the SR and the MAC PDU, it is necessary to identify whether a highest priority (a priority of a logical channel having a lowest priority value) among priorities of logical channels corresponding to the MAC CE and data among information included in the MAC PDU is higher than a priority of a logical channel that triggers the SR (1120). Here, the logical channel corresponding to data is a logical channel corresponding to an RLC device, and refers to a logical channel connecting a MAC layer and an RLC layer. The MAC CE may have a logical channel ID indicating which MAC CE it is, but the logical channel ID does not mean an actual logical channel. A highest priority among priorities of logical channels corresponding to the MAC CE and data among information included in the MAC PDU may be defined as a priority of the corresponding MAC PDU. In step 1120, if a highest priority among priorities of logical channels corresponding to the MAC CE and data among information included in the MAC PDU is higher than a priority of a logical channel that triggers the SR, it is considered that the priority of the MAC PDU is higher; thus the MAC PDU may have a priority (1130). Because the MAC PDU has a priority, the MAC PDU may be transferred to a lower physical layer. If a highest priority among priorities of logical channels corresponding to the MAC CE and data among information included in the MAC PDU is lower than a priority of a logical channel that triggers the SR (1140), it is considered that the priority of the SR is higher; thus, the SR may have a priority (1150). Because the SR has a priority, the SR may be transferred to a lower physical layer or SR transmission may be requested to the physical layer. If the two priorities are the same, it is possible to determine which one has a priority by the same priority determination method (1160). The same priority determination method may be one of methods described with reference to FIGS. 12, 13 and 14. Accordingly, a specific method of determining the same priority will be described later.

FIG. 12 illustrates a method of determining priorities in resource collision between a scheduling request message and a MAC PDU (PUSCH) of the same priority. A collision between SR and PUSCH resources may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, when a resource collision between the SR and the MAC PDU (PUSCH) occurs, the terminal may compare priorities of two resources by priorities of logical channels (or logical channels and MAC CE) defined in FIGS. 3, 4, 5, 6, 8, 9, 11, 12 and the like, as described above. In an embodiment of FIG. 12, it is assumed that the collided SR and PUSCH have the same priority (1210). Even in this case, a process of selecting and transmitting one of the two resources is required, and whether the MAC PDU includes a MAC CE may be one of determination factors of a prioritization process of selecting the resource (1220). If the MAC PDU includes a MAC CE, the MAC PDU may be transmitted with a priority (1230). If the MAC PDU does not include a MAC CE, the SR may have a priority (1240). As described above, the embodiment of FIG. 12 may be applied to the method of determining the same priority disclosed in FIGS. 3, 4, 5, 6, 8, 9, 11, 12, and the like.

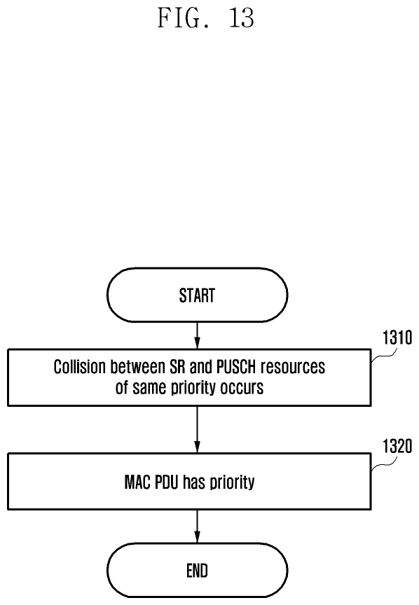

FIG. 13 illustrates a method of determining priorities in resource collision between a scheduling request message and a MAC PDU (PUSCH) of the same priority. A collision between SR and PUSCH resources may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, in case that a resource collision between the SR and the MAC PDU (PUSCH) occurs, the terminal may compare the priorities of two resources by priorities of logical channels (or logical channels and MAC CE) defined in FIGS. 3, 4, 5, 6, 8, 9, 11, 12 and the like, as described above. In an embodiment of FIG. 13, it is assumed that the collided SR and PUSCH have the same priority (1310). Even in this case, a process of selecting and transmitting one of the two resources is required, and in this case, a MAC PDU capable of actually transmitting data may be transmitted with a priority (1320). The embodiment of FIG. 13 may be applied to the method of determining the same priority described with reference to FIGS. 3, 4, 5, 6, 8, 9, 11, 12, and the like, as described above.

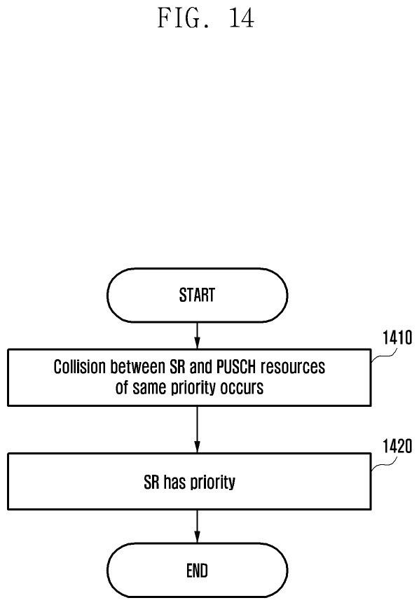

FIG. 14 illustrates a method of determining priorities in resource collision between a scheduling request message and a MAC PDU (PUSCH) of the same priority. A collision between SR and PUSCH resources may mean that the SR is triggered and should be transmitted from a configured SR resource. Accordingly, there is a situation in which a MAC PDU to be transmitted is generated and should be transmitted from the corresponding PUSCH resource, which means that the SR resource and the MAC PDU resource use the same resource on a time axis or time and frequency axes. For example, an uplink resource for transmitting an SR and an uplink resource for transmitting a MAC PDU (PUSCH) may overlap on the time axis. In this way, in case that a resource collision between the SR and the MAC PDU (PUSCH) occurs, the terminal may compare the priorities of two resources by a priority of logical channels (or logical channels and MAC CE) defined in FIGS. 3, 4, 5, 6, 8, 9, 11, 12 and the like, as described above. In an embodiment of FIG. 14, it is assumed that the collided SR and PUSCH have the same priority (1410). Even in this case, a process of selecting and transmitting one of the two resources is required, and in this case, the SR may transmit a message requesting allocation of a special radio resource with a priority (1420). The embodiment of FIG. 14 may be applied to the method of determining the same priority as described with reference to FIGS. 3, 4, 5, 6, 8, 9, 11, 12, and the like, as described above.

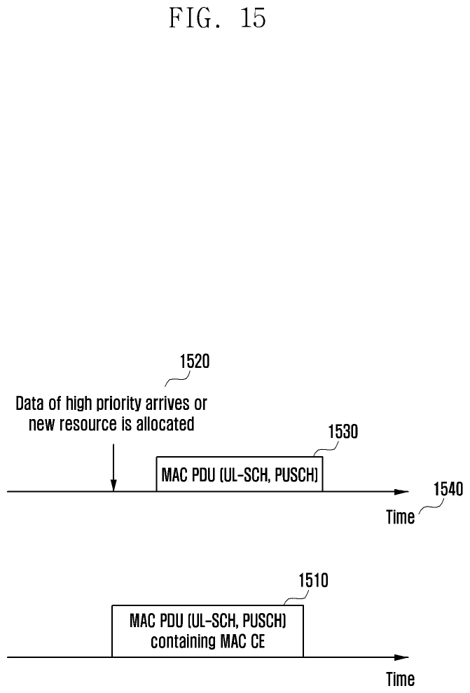

FIG. 15 illustrates a collision scenario between sequentially occurring MAC PDUs. The terminal may receive allocation of a MAC PDU capable of transmitting data from the base station (1510, 1530). These MAC PDUs are resources transmitted corresponding to an uplink shared channel (UL-SCH) and a physical uplink shared channel, and may be allocated by the base station. In this way, the resource for transmitting the MAC PDU may be dynamically allocated by the base station or may be allocated with a configured grant (CG) repeated until released by a static configuration. Resources for transmitting each MAC PDU (1510, 1530) may overlap on a time axis (1540) or time and frequency axes, and in this case, the terminal may have to select and transmit one of the two resources. This is referred to as a collision problem between MAC PDUs (or between PUSCHs). In an embodiment of FIG. 15, in step 1510, the MAC PDU 1510 including a MAC CE is first generated, and then data of a high priority arrives at a time point indicated by reference numeral 1520 and/or a new resource is allocated, and it is assumed that the MAC PDU may be generated at a time point indicated by reference numeral 1530. In this case, because one MAC PDU 1510 has already been generated, it is necessary to determine whether to actually generate the MAC PDU at the time point of the reference numeral 1530.

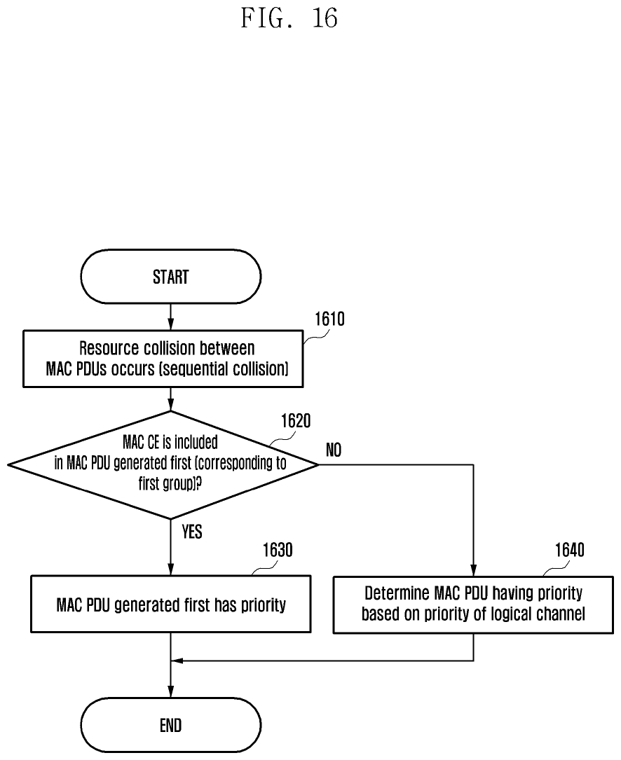

FIG. 16 illustrates a method of determining priorities in a collision scenario between MAC PDUs (PUSCHs). A collision between PUSCH resources means that there is a situation in which two or more MAC PDUs to be transmitted are generated and should be transmitted from the corresponding PUSCH resources, which means that the MAC PDU resources use the same resource on a time axis or time and frequency axes. For example, uplink resources for transmitting the MAC PDU may overlap on the time axis. In this way, in case that a resource collision between MAC PDUs (PUSCHs) occurs (1610), a process of selecting and transmitting one of the two resources is required. In case that the collision between MAC PDUs is a collision between sequentially occurring MAC PDUs described with reference to FIG. 15, whether a specific MAC CE is included in a MAC PDU generated first may be one of determination factors in a prioritization process of selecting a resource (1620). Such a specific MAC CE may be a MAC CE considered to be processed first with a higher priority than that of data among all MAC CEs. Hereinafter, the MAC CE determined to be processed first is referred to as a MAC CE corresponding to a first group. Otherwise, a MAC CE considered acceptable to be processed with a lower priority than that of data is referred to as a MAC CE corresponding to the second group. If the MAC PDU includes a MAC CE corresponding to the first group, it is considered that a priority of the MAC PDU is higher because the MAC CE corresponding to the first group is included in the MAC PDU; thus, the MAC PDU generated first may have a priority (1630). For example, because the MAC PDU including the MAC CE has a priority, the MAC PDU may be transferred to a lower physical layer. A MAC PDU that does not have a priority may not be generated. The MAC CE corresponding to the first group described in step 1620 may be, for example, a regular BSR, a periodic BSR, or a beam failure recovery (BFR) request. The MAC CE corresponding to the second group may be a MAC CE for padding, a recommended bit rate query MAC CE, and a MAC CE of a low priority such as a padding buffer status report (BSR). However, whether the MAC CE corresponding to the first group or the MAC CE corresponding to the second group is selected may vary according to an embodiment.

If the MAC PDU generated first does not include a MAC CE corresponding to the first group, by defining a highest priority (a priority of a logical channel having a lowest priority value) among a priority of a MAC CE (the MAC CE corresponding to the second group) other than the first group and a priority of a logical channel corresponding to data among information included in the MAC PDU as the priority of the corresponding MAC PDU, it is possible to compare which MAC PDU has the highest priority. Accordingly, a MAC PDU having a higher priority may be transmitted with a priority (1640). If the priority of the MAC PDU generated first is high, other MAC PDUs do not need to be generated. If a priority of a MAC PDU that has not yet been generated is high, the MAC PDU may be generated and transferred to the lower physical layer. In another embodiment, priority may not be given to the MAC CE corresponding to the second group, and in this case, in step 1640, a highest priority among priorities of logical channels corresponding to data may be defined as a priority of the corresponding MAC PDU.

In an embodiment of FIG. 16, when the MAC CE is included in the MAC PDU generated first, it is assumed that the MAC PDU may have a priority, but the reverse case is also applicable. In other words, in case that the MAC PDU generated first does not include a MAC CE of a first form, but in case that the MAC PDU that has not yet been generated includes a MAC CE, the MAC PDU that has not yet been generated may have a priority and be transmitted from the PUSCH.

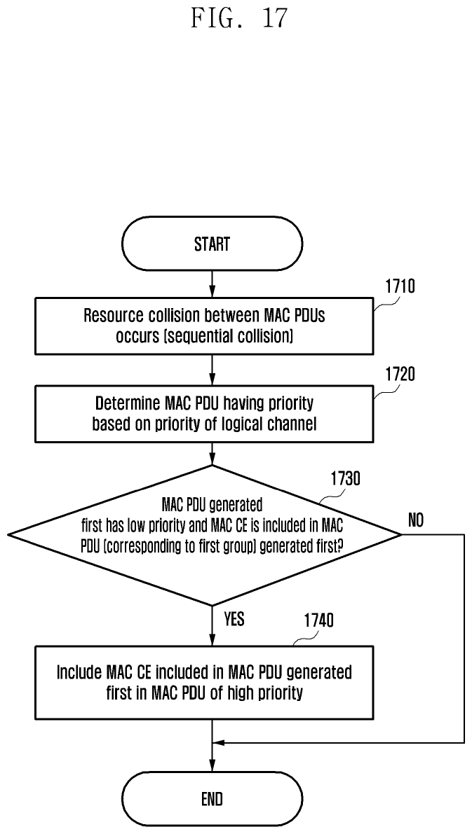

FIG. 17 illustrates a method of determining priorities in a collision scenario between MAC PDUs (PUSCHs). A collision between PUSCH resources means that there is a situation in which two or more MAC PDUs to be transmitted are generated and should be transmitted from the corresponding PUSCH resources and that these MAC PDU resources use the same resource on a time axis or time and frequency axes. For example, uplink resources for transmitting the MAC PDU may overlap on the time axis. In this way, in case that a resource collision between MAC PDUs (PUSCHs) occurs (1710), a process of selecting and transmitting one of the two resources is required. In case that a collision between these MAC PDUs is a collision between sequentially occurring MAC PDUs described with reference to FIG. 15, the MAC PDU having a priority may be determined based on the priority configured to a logical channel of data included in the collided MAC PDUs (1720). Specifically, a highest priority among priorities configured to logical channels of data included in each MAC PDU may be selected as a priority of the corresponding MAC PDU, and a MAC PDU having a higher priority may be determined based on the selection. In case that the priority value is configured to the MAC CE, a highest priority among priorities for the MAC CE and data included in the MAC PDU may be selected as the priority of the corresponding MAC PDU.

In this case, when the MAC PDU generated first has a low priority, for example, when the MAC PDU generated first does not have a priority, the MAC PDU having the low priority may not be transmitted. However, in case that the MAC PDU generated first has a low priority, but in case that a specific MAC CE is included in a MAC PDU generated first (1730), the MAC CEs may be included in the MAC PDU generated later having a priority and transmitted (1740). Thereby, although the MAC PDU is not transmitted with a low priority, a MAC CE included therein enables fast transmission, thereby reducing a delay time of control information. The specific MAC CE described in steps 1730 and 1740 may be a MAC CE corresponding to the first group.

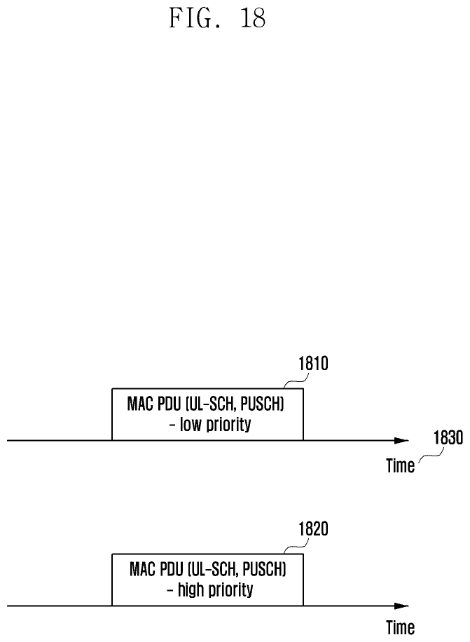

FIG. 18 illustrates a collision scenario between independently occurring MAC PDUs. The terminal may receive allocation of a MAC PDU capable of transmitting data from the base station (1810, 1820). For example, the terminal may receive allocation of an uplink transmission resource for transmitting the MAC PDU. Such a MAC PDU is a resource transmitted corresponding to an uplink shared channel (UL-SCH) and a physical uplink shared channel, and may be allocated by the base station. In this way, a resource for transmitting the MAC PDU may be dynamically allocated by the base station or may be allocated with a configured grant (CG) repeated until released by a static configuration. Resources for transmitting each MAC PDU (1810, 1820) may overlap on a time axis 1830 or time and frequency axes, and in this case, one of two resources may have to be selected and transmitted. This is referred to as a collision problem between MAC PDUs (or between PUSCHs). In an embodiment of FIG. 18, it is assumed that two resources collide at a time point in which two MAC PDUs 1810 and 1820 are not generated. In this case, because the MAC PDU is not generated, the terminal may generate and transmit one MAC PDU 1820 having a priority. Therefore, the MAC PDU 1810 having a low priority may not need to be generated.

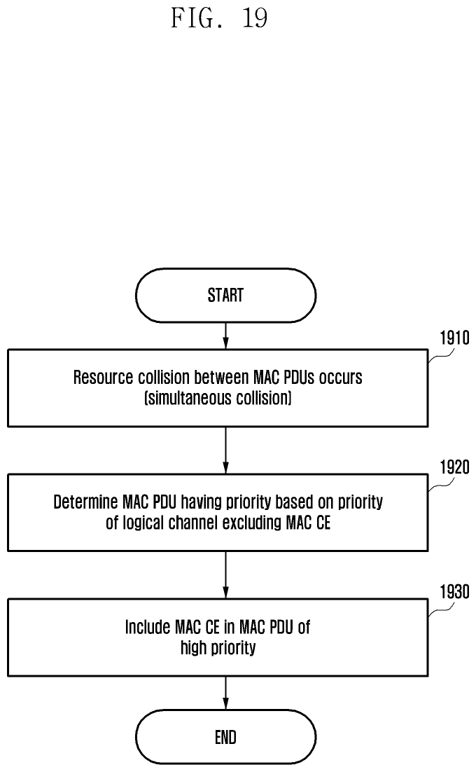

FIG. 19 illustrates a method of determining priorities in a collision scenario between MAC PDUs (PUSCHs). A collision between PUSCH resources means that there is a situation in which two or more MAC PDUs to be transmitted are generated and should be transmitted from the corresponding PUSCH resources and that these MAC PDU resources use the same resource on a time axis or time and frequency axes. In this way, when a resource collision between MAC PDUs (PUSCHs) occurs (1910), a process of selecting and transmitting one of the two resources is required. If the collision between these MAC PDUs is a collision between independently generating MAC PDUs (simultaneous collision) described with reference to FIG. 18, the MAC PDU having a priority may be determined based on the priority of the logical channel of data excluding the MAC CE. For example, a MAC PDU having a priority may be determined based on the highest priority of a logical channel of data having data to be transmitted excluding the MAC CE. However, in some embodiments, the MAC CE may have a priority value, and in this case, both the logical channel of data and the priority of the MAC CE are considered; thus, the priority of the MAC PDU may be determined with data to be included in the colliding MAC PDU and the highest priority of the MAC CE (1920). Thereafter, the MAC PDU having the priority is transmitted, and the MAC PDU having a priority to be transmitted may include the MAC CE and be transmitted (1930).

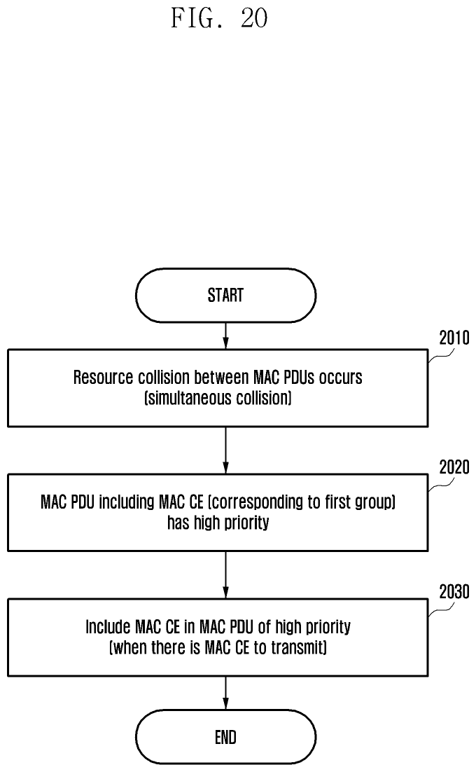

FIG. 20 illustrates a method of determining priorities in a collision scenario between MAC PDUs (PUSCHs). A collision between PUSCH resources means that there is a situation in which two or more MAC PDUs to be transmitted are generated and should be transmitted from the corresponding PUSCH resources and that these MAC PDU resources use the same resource on a time axis or time and frequency axes. In this way, when a resource collision between MAC PDUs (PUSCHs) occurs (2010), the terminal needs to select and transmit one of the two resources. When a collision between MAC PDUs is a collision between independently occurring MAC PDUs (simultaneous collision) described with reference to FIG. 18, whether a specific MAC CE is included in the MAC PDU may be one of determination factors of a prioritization process of selecting a resource. The specific MAC CE may be a MAC CE considered to be processed first with a higher priority than that of data among all MAC CEs. Hereinafter, a MAC CE determined to be processed first is referred to as a MAC CE corresponding to a first group. Otherwise, a MAC CE considered acceptable to be processed with a lower priority than that of data is referred to as a MAC CE corresponding to a second group. When a MAC CE corresponding to the first group may be included in any one MAC PDU of the colliding MAC PDUs, it is considered that the MAC PDU has a higher priority; thus, the MAC PDU may have a priority (2020). For example, the terminal may determine whether a MAC CE preconfigured to a first group MAC CE from the base station is included in the MAC PDU. If a MAC CE corresponding to the first group is included in the MAC PDU, the terminal may determine that transmission of the MAC PDU has a priority over other MAC CEs. Because the MAC PDU including the MAC CE has a priority, the MAC PDU including the MAC CE may be transferred to a lower physical layer (2030). In this case, a MAC PDU that does not have a priority may not be generated. The MAC CE corresponding to the first group described in step 2020 may be, for example, a regular BSR, a periodic BSR, a beam failure recovery (BFR) request, and the like. A MAC CE corresponding to the second group may be a MAC CE for padding, a recommended bit rate query request MAC CE, and a MAC CE of a low priority such as a padding buffer status report (BSR). However, whether the MAC CE corresponding to the first group or the MAC CE corresponding to the second group is selected may vary according to an embodiment.

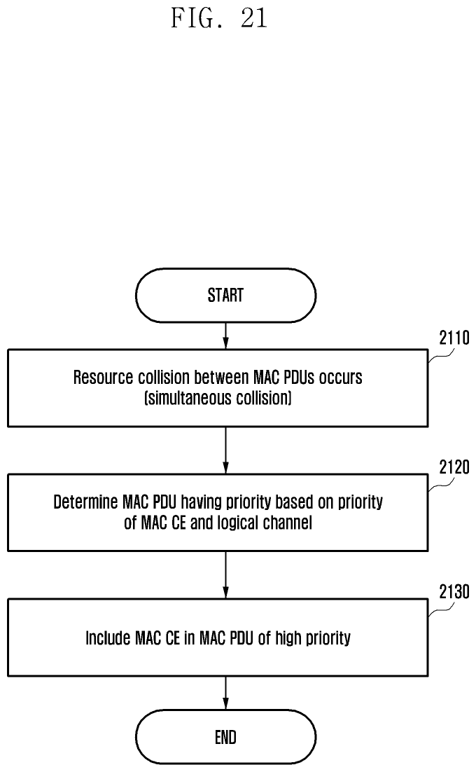

FIG. 21 illustrates a method of determining priorities in a collision scenario between MAC PDUs (PUSCHs). A collision between PUSCH resources means that there is a situation in which two or more MAC PDUs to be transmitted are generated and should be transmitted from the corresponding PUSCH resources and that these MAC PDU resources use the same resource on a time axis or time and frequency axes. In this way, when a resource collision between MAC PDUs (PUSCHs) occurs (2110), a process of selecting and transmitting one of the two resources is required. When a collision between these MAC PDUs is a collision between independently occurring MAC PDUs (simultaneous collision) described with reference to FIG. 18, a MAC PDU having a priority may be determined based on a priority of the logical channel of data and the MAC CE. For example, a MAC PDU having a priority may be determined based on a highest priority among priorities of all logical channels included in the MAC PDU. In this embodiment, it is assumed that the MAC CE may have a priority value. For example, the terminal may have previously configured a priority value according to the MAC CE from the base station or may use a priority value of the MAC CE configured as a default to the terminal. After step 2120, the MAC PDU having the priority is transmitted, and the MAC PDU having a priority to be transmitted may include the MAC CE and be transmitted (2130).

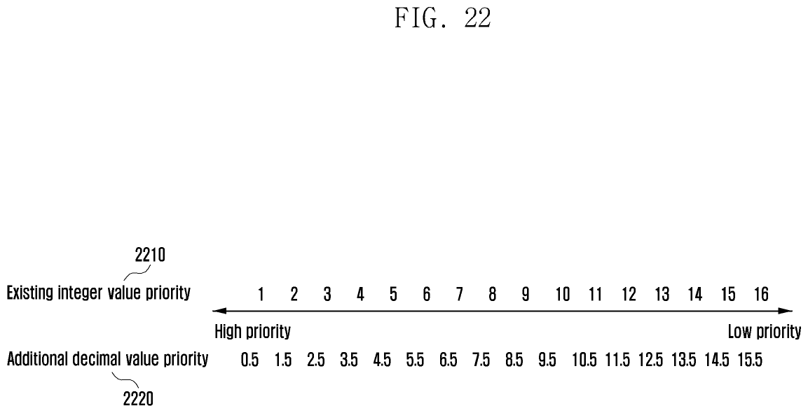

FIG. 22 illustrates a method of configuring a decimal value priority for a logical channel. Conventionally, an integer priority value is given to a logical channel for data; thus, a relative priority of each logical channel may be distinguished (2210). In this case, because a small priority value means a high priority, it was possible to have a priority in the logical channel prioritization process and the collided resource prioritization process. An embodiment of FIG. 22 illustrates that integer (natural number) values of priorities from 1 to 16 may be configured. However, in order to enable control information other than data such as a MAC CE to have a relative priority with data in a logical channel prioritization process, a priority value may be given to the control information. When a priority of an integer value from 17 following the previously configured integer value is configured, a logical channel having a large integer value always has a lower priority than the previously configured priority value. Alternatively, the priority value may have a decimal value to indicate a more specific priority within the existing priority range (2220). In an embodiment of FIG. 22, it is assumed that 16 priorities from 0.5 to 15.5 are added so that more priorities may be added out of the existing range. Thereby, it is possible to indicate a more specific priority while enabling an existing low priority value to indicate a higher priority.

In some embodiments, a priority of such a decimal value may be limitedly applied only to the MAC CE. Conversely, only logical channels for data may have an integer priority. In this case, when the priorities of the MAC PDU including the MAC CE and the logical channel without the MAC CE are compared, the same priority does not occur; thus, accurate prioritization may be possible.

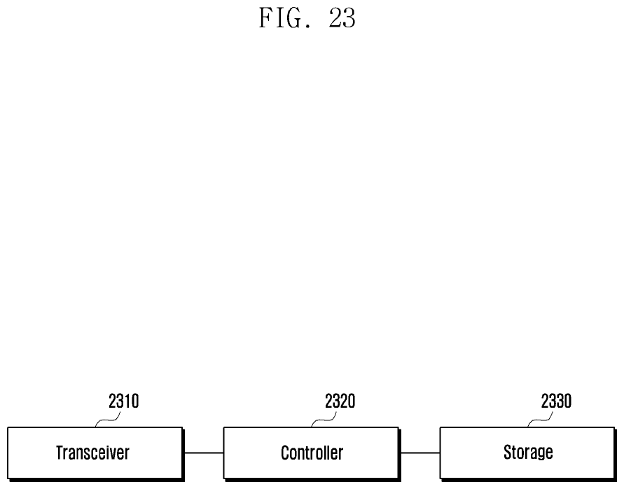

FIG. 23 is a block diagram illustrating a structure of a base station according to an embodiment of the disclosure.

With reference to FIG. 23, the base station may include a transceiver 2310, a controller 2320, and a storage 2330. In the disclosure, the controller 2320 may be defined as a circuit, an application specific integrated circuit, or at least one processor.

The transceiver 2310 may transmit and receive signals to and from other network entities. The transceiver 2310 may transmit, for example, system information to the terminal, and transmit a synchronization signal or a reference signal.

The controller 2320 may control the overall operation of the base station according to the embodiment proposed in the disclosure. For example, the controller 2320 may control a signal flow between blocks to perform an operation according to the above-described flowchart.

The storage 2330 may store at least one of information transmitted and received through the transceiver 2310 or information generated through the controller 2320.

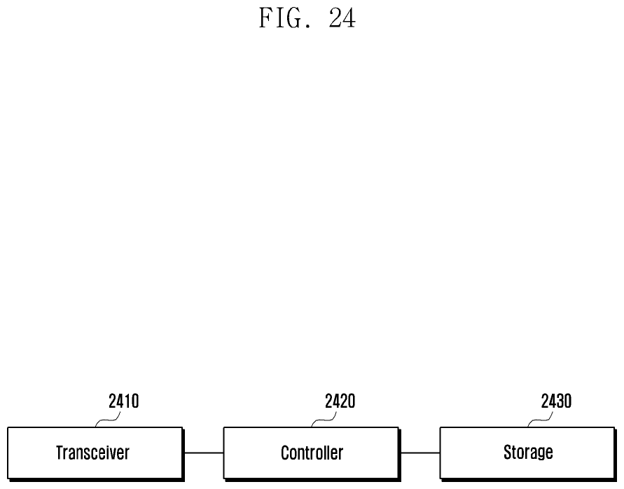

According to an embodiment of the disclosure, when an uplink resource for transmitting an SR collides with an uplink resource for transmitting a MAC PDU (PUSCH), if the MAC CE is included in the MAC PDU, the controller 2320 may be configured to transmit the MAC PDU including the MAC CE. Further, the controller 2320 may configure a MAC CE corresponding to the first group and a MAC CE corresponding to the second group to the terminal. Accordingly, when the uplink resource for transmitting the SR collides with the uplink resource for transmitting the MAC PDU (PUSCH), the controller 2320 may be configured to transmit the MAC PDU including the MAC CE configured to the first group. FIG. 24 is a block diagram illustrating a structure of a terminal according to an embodiment of the disclosure.

With reference to FIG. 24, the terminal may include a transceiver 2410, a controller 2420, and a storage 2430. In the disclosure, the controller may be defined as a circuit, an application specific integrated circuit, or at least one processor.

The transceiver 2410 may transmit and receive signals to and from other network entities. The transceiver 2410 may receive, for example, system information from a base station, and receive a synchronization signal or a reference signal.

The controller 2420 may control the overall operation of the terminal according to the embodiment proposed in the disclosure. For example, the controller 2420 may control a signal flow between blocks to perform an operation according to the above-described flowchart. According to an embodiment of the disclosure, the controller 2420 may identify whether a first uplink (UL) resource and a second UL resource overlap in time.

In case that the first UL resource and the second UL resource overlap in time, the controller 2420 may determine whether a medium access control (MAC) control element (CE) is included in at least one of the first UL resource or the second UL resource.

Further, the controller 2420 may control the transceiver 2410 to transmit the UL resource including the MAC CE from the first UL resource and the second UL resource.

The storage 2430 may store at least one of information transmitted and received through the transceiver 2410 or information generated through the controller 2420.

By the above-described base station and terminal, a collision problem between a resource for transmitting a scheduling request (SR) and a resource for transmitting a medium access control (MAC) protocol data unit (PDU) and a collision problem between resources for transmitting two or more MAC PDUs can be easily solved.

Methods according to the embodiments described in the claims or specifications of the disclosure may be implemented in the form of hardware, software, or a combination of hardware and software.

In the case of implementing software, a computer readable storage medium storing one or more programs (software modules) may be provided. One or more programs stored in the computer readable storage medium are configured for execution by one or more processors in an electronic device. The one or more programs include instructions for causing an electronic device to execute methods according to embodiments described in a claim or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), any other form of optical storage device, or a magnetic cassette. Alternatively, the programs may be stored in a memory configured with a combination of some or all thereof. Further, each configuration memory may be included in the plural.

Further, the program may be stored in an attachable storage device that may access through a communication network such as the Internet, Intranet, local area network (LAN), wide LAN (WLAN), or storage area Network (SAN), or a communication network configured with a combination thereof. Such a storage device may access to a device implementing an embodiment of the disclosure through an external port. Further, a separate storage device on a communication network may be accessed to a device implementing the embodiment of the disclosure.

In the specific embodiments of the disclosure described above, elements included in the disclosure are expressed in the singular or plural according to the specific embodiments presented. However, the singular or plural expression is appropriately selected for a situation presented for convenience of description, and the disclosure is not limited to the singular or plural element, and even if a component is represented in the plural, it may be configured with the singular, or even if a component is represented in the singular, it may be configured with the plural.

In the detailed description of the disclosure, although specific embodiments have been described, various modifications are possible without departing from the scope of the disclosure. Therefore, the scope of the disclosure should not be limited to the described embodiments and should be defined by the claims described below as well as by those equivalent to the claims.

1. A method of controlling a terminal in a wireless communication system, the method comprising:
identifying whether a first uplink (UL) resource and a second UL resource overlap in time;
determining, in case that the first UL resource and the second UL resource overlap in time, whether a medium access control (MAC) control element (CE) is included in at least one of the first UL resource or the second UL resource; and
transmitting an UL resource including the MAC CE from the first UL resource and the second UL resource.

2. The method of claim 1, wherein determining further comprises:
determining, in case that the first UL resource is a resource configured to transmit a scheduling request (SR) and the second UL resource is a resource configured to transmit a MAC protocol data unit (PDU), whether the MAC CE is included in the MAC PDU, and
determining that the second UL resource has a priority over the first UL resource in case that the MAC CE is included in the MAC PDU.

3. The method of claim 1, wherein determining further comprises:
determining, in case that the first UL resource is a resource configured to transmit an SR and the second UL resource is a resource configured to transmit a MAC PDU, whether the MAC CE is included in the MAC PDU,
determining, in case that the MAC CE is not included in the MAC PDU, whether a highest priority among corresponding priorities of data included in the MAC PDU is higher than a priority of a logical channel that triggers the SR, and
determining, in case that a highest priority among corresponding priorities of data included in the MAC PDU is higher than a priority of an LCH that triggers the SR, that the second UL resource has a priority over the first UL resource.

4. The method of claim 1,
wherein determining further comprises:
determining, in case that the first UL resource is a resource configured to transmit an SR and the second UL resource is a resource configured to transmit a MAC PDU, whether a MAC CE corresponding to a preconfigured first group is included in the MAC PDU, and
determining, in case that a MAC CE corresponding to a preconfigured first group is included in the MAC PDU, that the second UL resource has a priority over the first UL resource, and
wherein the MAC CE corresponding to the preconfigured first group is a MAC CE corresponding to at least one of a regular buffer status report (BSR), a periodic BSR, or a beam failure recovery (BFR) request.

5. The method of claim 1, further comprising:
identifying, in case that the first UL resource is a resource configured to transmit an SR and the second UL resource is a resource configured to transmit a MAC PDU, whether an LCH that triggers the SR is a preconfigured LCH for ultra reliable low latency communication (URLCC);
transmitting the SR in case that an LCH that triggers the SR is a preconfigured LCH for URLCC;
determining, in case that an LCH that triggers the SR is not a preconfigured LCH for URLCC, whether a MAC CE corresponding to a preconfigured first group is included in the MAC PDU; and
transmitting the MAC PDU in case that a MAC CE corresponding to a preconfigured first group is included in the MAC PDU.

6. The method of claim 1,
wherein determining comprises:
determining, in case that the first UL resource and the second UL resource are resources configured to transmit a MAC PDU, whether a medium access control (MAC) control element (CE) is included in a MAC PDU corresponding to at least one of the first UL resource or the second UL resource, and
wherein transmitting an UL resource including the MAC CE comprises transmitting the MAC PDU corresponding to the first UL resource in case that the MAC PDU corresponding to the first UL resource includes the MAC CE and the MAC PDU corresponding to the second UL resource does not include the MAC CE.

7. The method of claim 6,
wherein determining whether a medium access control (MAC) control element (CE) further comprises:
determining, in case that the MAC PDU corresponding to the first UL resource includes the MAC CE and the MAC PDU corresponding to the second UL resource does not include the MAC CE, whether a MAC CE corresponding to the preconfigured first group is included in the MAC PDU, and
determining, in case that a MAC CE corresponding to the preconfigured first group is included in the MAC PDU, that the first UL resource has a priority over the second UL resource, and
wherein the MAC CE corresponding to the preconfigured first group is a MAC CE corresponding to at least one of a regular buffer status report (BSR), a periodic BSR, or a beam failure recovery (BFR) request.

8. A terminal in a wireless communication system, the terminal comprising:
a transceiver; and
a controller configured to:
identify whether a first uplink (UL) resource and a second UL resource overlap in time, to determine whether a medium access control (MAC) control element (CE) is included in at least one of the first UL resource or the second UL resource in case that the first UL resource and the second UL resource overlap in time, and
control the transceiver to transmit an UL resource including the MAC CE from the first UL resource and the second UL resource.

9. The terminal of claim 8, wherein the controller is configured to:
determine, in case that the first UL resource is a resource configured to transmit a scheduling request (SR) and the second UL resource is a resource configured to transmit a MAC protocol data unit (PDU), whether the MAC CE is included in the MAC PDU, and
determine that the second UL resource has a priority over the first UL resource in case that the MAC CE is included in the MAC PDU.

10. The terminal of claim 8, wherein the controller is configured to:
determine, in case that the first UL resource is a resource configured to transmit an SR and the second UL resource is a resource configured to transmit a MAC PDU, whether the MAC CE is included in the MAC PDU,
determine whether a highest priority among corresponding priorities of data included in the MAC PDU is higher than a priority of a logical channel that triggers the SR in case that the MAC CE is not included in the MAC PDU, and
determine that the second UL resource has a priority over the first UL resource in case that a highest priority among corresponding priorities of data included in the MAC PDU is higher than a priority of an LCH that triggers the SR.

11. The terminal of claim 8,
wherein the controller is configured to:
determine, in case that the first UL resource is a resource configured to transmit an SR and the second UL resource is a resource configured to transmit a MAC PDU, whether a MAC CE corresponding to a preconfigured first group is included in the MAC PDU, and
determine that the second UL resource has a priority over the first UL resource in case that a MAC CE corresponding to a preconfigured first group is included in the MAC PDU, and
wherein the MAC CE corresponding to the preconfigured first group is a MAC CE corresponding to at least one of a regular buffer status report (BSR), a periodic BSR, or a beam failure recovery (BFR) request.

12. The terminal of claim 8, wherein the controller is configured to:
identify whether an LCH that triggers the SR is a preconfigured LCH for ultra reliable low latency communication (URLCC) in case that the first UL resource is a resource configured to transmit an SR and the second UL resource is a resource configured to transmit a MAC PDU,
transmit the SR in case that an LCH that triggers the SR is a preconfigured LCH for URLCC,
determine whether a MAC CE corresponding to a preconfigured first group is included in the MAC PDU in case that an LCH that triggers the SR is not a preconfigured LCH for URLCC, and
control the transceiver to transmit the MAC PDU in case that a MAC CE corresponding to the preconfigured first group is included in the MAC PDU.

13. The terminal of claim 8, wherein the controller is configured to:
determine, in case that the first UL resource and the second UL resource are resources configured to transmit a MAC PDU, whether a medium access control (MAC) control element (CE) is included in a MAC PDU corresponding to at least one of the first UL resource or the second UL resource, and
control, in case that a MAC PDU corresponding to the first UL resource includes the MAC CE and a MAC PDU corresponding to the second UL resource does not include the MAC CE, the transceiver to transmit the MAC PDU corresponding to the first UL resource.

14. The terminal of claim 13,
wherein the controller is configured to:
determine, in case that a MAC PDU corresponding to the first UL resource includes the MAC CE and a MAC PDU corresponding to the second UL resource does not include the MAC CE, whether a MAC CE corresponding to the preconfigured first group is included in the MAC PDU, and
determine that the first UL resource has a priority over the second UL resource in case that a MAC CE corresponding to the preconfigured first group is included in the MAC PDU, and
wherein the MAC CE corresponding to the preconfigured first group is a MAC CE corresponding to at least one of a regular buffer status report (BSR), a periodic BSR, or a beam failure recovery (BFR) request.
